(19) United States
(12) Patent Application Publication
(10) Pub. No.: US 2004/0119292 A1
(43) Pub. Date: Jun. 24, 2004

(54) Method and configuration for controlling a wind energy installation without a gearbox by electronically varying the speed

(76) Inventors: Rajib Datta, Schenectady, NY (US); Steffen Bernet, Bammental (DE); Harry Reinold, Landau-Morzheim (DE)

Correspondence Address: LERNER AND GREENBERG, PA, P O BOX 2480, HOLLYWOOD, FL, 33022-2480, US

(21) Appl. No.: 10/733,733

(22) Filed: Dec. 11, 2003

Related U.S. Application Data
(63) Continuation of application No. PCT/EP02/07903, filed on Jul. 16, 2002.

(30) Foreign Application Priority Data
Jul. 18, 2001 (DE) 101 34 883.5

(51) Int. Cl. F03D 9/00; H02P 9/04

(52) U.S. Cl. 290/44

(57) ABSTRACT

The electronic generator power P_{G} is compared with a predetermined power range in order to set the torque of the synchronous generator of a wind energy installation. A choice between two control modes is made on the basis of the comparison, and a reference power P_{G}* is determined that corresponds to the maximum power production. This reference power P_{G}* is compared with the electrical generator power P_{G}, and a reference current I_{E}* that is proportional to the power difference is produced and supplied to the field controller. The field controller draws power in a controlled manner from the capacitive DC voltage intermediate circuit as a function of the reference current I_{E}*, and supplies this power to the excitation field. Changing the excitation field results in a change in the torque and hence in the rotational speed of the synchronous generator, which enables the two power values to be matched.

### CROSS-REFERENCE TO RELATED APPLICATION

This application is a continuation of copending International Application No. PCT/EP02/07903, filed Jul. 16, 2002, which designated the United States and was not published in English.

### BACKGROUND OF THE INVENTION

Field of the Invention

The invention relates to a method and a configuration for controlling the power of a wind energy installation without a gearbox by electronically varying the speed. The invention relates in particular to a wind energy installation that is on the high seas, but close to the coast (offshore wind energy installation). The method and configuration allow the power production to be maximized at all times when the wind speeds vary to a major extent.

The discovery and exploitation of renewable energy sources, in particular wind energy, using two or more wind energy installations which are interconnected to form a wind park is becoming ever more important in an age where fossil fuels, such as coal, brown coal and natural oil will become exhausted in the long term. Renewable energy sources are also important since there is a continuous increase in the environmental contamination from exhaust gases and combustion residues, and from the consequences that result from them.

Wind power or wind energy installations have towers that normally have a height of several tens of meters. A gondola, which is located at the top of the tower, is provided for accommodating a wind turbine with a rotor that generally has one to three rotor blades. Such a wind energy installation further generally also has a generator that is coupled to the turbine, possibly with an intermediate gearbox. The generators that are used for wind power or wind energy installations are in most cases asynchronous generators since, because of their comparatively simple and robust construction, they are highly reliable in operation and result in only minor maintenance costs. When these generators are connected directly to the respective electrical power or supply grid, then the turbine rotation speed, which is generally in the region between 18 and 25 revolutions per minute, must be matched using an intermediate gearbox to the generator rotation speed, which is predetermined by the respective grid frequency to be 50 or 60 Hertz. The turbine rotation speed, which is thus predetermined at a fixed frequency by the grid frequency, of the wind energy installation has a disadvantageous effect on the power yield and on the amount of energy that can be recovered when the wind conditions change or vary. The available wind force or wind energy cannot be utilized and exploited completely in this case and, in consequence, the maximum possible power cannot be generated or produced either.

Since asynchronous generators always require an inductive wattless component for operation, wind energy installations mainly draw an inductive wattless component from the group grid system when the wind strengths are low, when the real power that is being produced is low, and when the power factor is poor.

In most cases, the inductive wattless component is compensated for by using intermediate capacitor banks. Depending on the real power that is being produced, these capacitor banks are either connected to the circuit or disconnected from the circuit, in order in this way to improve the power factor of the generator. However, this arbitrary connection and disconnection of the capacitor banks leads to undesirable transients in the grid current and in the grid voltage.

As is known, the use of active rectifiers in the stator circuit of an asynchronous generator with a squirrel-cage rotor and when the grid frequency is constant allows the wind turbine to be operated in a mode with variable rotation speeds. Despite changing wind conditions, vector control makes it possible to control not only the machine torque but also the rotation speed, and hence to control the installation at the point of maximum power production (MPP). In an arrangement such as this, it is absolutely essential to have an inverter that operates on the grid side and that feeds the energy that is obtained into the grid system, in addition to the active rectifier on the generator side.

When using asynchronous generators, a gearbox is required for rotation speed matching, although this leads to an increased servicing and maintenance penalty. The active inverter that has to be provided and the increased installation costs incurred as a result of it as well as the reduced reliability and availability are also regarded as disadvantages of a corresponding wind energy installation.

The use of a double-feed induction or asynchronous generator and of a rotor controller or monitoring device admittedly allows power-related reduction in the size of the active inverter on the generator side, and thus also allows a reduction in the installation costs incurred, but this minor financial advantage is counteracted again by the increased generator costs.

In the case of an arrangement of this type, the stator of the generator is connected directly to the three-phase grid line, and the rotor is fed via an active inverter. Circuitry such as this allows the generator to be operated both below and above synchronous speed. Furthermore, this operating principle allows the installation to be controlled at the point of maximum power production (MPP) and allows a power factor of unity when feeding the grid system. The use of sliprings in addition to the gearbox that is still present has disadvantageous effects on reliability during operation.

Particularly in the case of wind power stations on the high seas, but close to the coast (offshore wind power stations) or wind parks, high reliability, little need for servicing and in consequence also low maintenance costs for the installations are of critical importance. Powerful turbines of more than one Megawatt are already justifying the comparatively high financial investments for installation and construction. Nevertheless, in this case, it is also important to keep the installation and operating costs of the electrical systems that are used as low as possible.

Since highly fluctuating wind strengths and speeds must be expected in the area of the high seas close to the coast, the systems mentioned above using asynchronous machines with gearbox coupling appear to be unsuitable for use at sea because of: the comparatively high mechanical loads and the severe wear on the gearbox, the susceptibility to defects and the operational unreliability associated with this, the high servicing penalty to be expected, and the high maintenance costs.

When coupling the generator to the grid system via converters, the use of active electronic power converters connected downstream from the generator leads to a reduction in the reliability of operation and to an increase in costs, particularly in the area of the high power levels of more than one Megawatt that have been mentioned. Furthermore, the losses that occur in the active power semiconductors in the active converter reduce its efficiency, thus making the financial viability of the power station system worse.

Wind turbines are characterized essentially by their power/speed characteristic, that is to say the power that is produced is related to or is a function of the rotation speed of the wind turbine and of its shaft. The amount of power PT which is produced by a wind turbine depends on the dimensions of the corresponding installation, on the geometry of the rotor blades, on the air density, and on the respective available wind speed. The power produced by a horizontally mounted wind turbine is given by the following relationship:

Pᵣ=0.5·Cₚ·ρ·A·v_{w}³ Equation I

where ρ is the air density, A is the area over which the wind flows, or the area covered by the rotor blades, and v_{w} is the wind speed.

The power coefficient Cₚ is dependent on the geometry of the rotor blades and on the speed coefficient λ, which is defined as the ratio of the speed of the rotor blade tip v_{R} to the wind speed v_{w}.

$$λ = \frac{{v}_{R}}{{v}_{W}} = \frac{ω \cdot R}{{v}_{W}} \qquad Equation II$$

where, in this case, ωis the angular velocity or rotation speed of the wind turbine and of the turbine shaft, and R is the radius of the turbine, measured from the center point of the rotation axis to the rotor blade tip.

The power coefficient Cₚ reaches its maximum for only one specific speed coefficient λ, and thus for a specific ratio of the tip speed v_{R} to the wind speed v_{w}. However, this means that there is an ideal rotor angular velocity or rotation speed for each wind speed v_{w}, which allows the installation to be operated in the limit range of maximum power production.

The critical factor for the development and implementation of variable speed control for a wind energy installation is accordingly the desire to determine and to set the optimized rotor angular velocity as a function of the prevailing wind speed such that the maximum power coefficient Cₚ and thus the maximum power production are always achieved from the wind energy installation, and can be maintained and ensured.

### SUMMARY OF THE INVENTION

It is accordingly an object of the invention to provide a configuration for controlling the power of at least one wind energy installation without a gearbox by electronically varying the speed and a method for controlling the power of at least one wind energy installation without a gearbox by electronically varying the speed, which overcome the above-mentioned disadvantages of the prior art apparatus and methods of this general type.

The invention is based on the object of allowing and ensuring that the power production from a wind power or wind energy installation without a gearbox is always maximized when the wind speed varies, in particular in the case of a wind power or wind energy installation that is on the high seas, but is close to the coast (offshore wind energy installation).

With the foregoing and other objects in view there is provided, in accordance with the invention, a configuration or apparatus and a method for controlling the power of at least one wind energy installation without a gearbox by electronically varying the speed of the generator. One or more wind energy installations can be regulated and controlled separately, have no gearbox, and can be coupled via a capacitive DC voltage intermediate circuit to form a group. In particular, such a wind energy installation is located on the high seas, but close to the coast. Each wind energy installation has a tower with a height of several tens of meters and a gondola with a wind turbine and a generator unit mounted at the tip. Each wind energy installation has at least one converter unit for feeding the grid system, an active electronic power control unit or a field controller for torque and thus rotation speed control, as well as a corresponding control apparatus, which is preferably modular.

In order to reach and to maintain the point of maximum power production from a wind energy installation without a gearbox, in particular a wind energy installation which is on the high seas and close to the coast, when the wind speeds are varying, the rotation speed of the rotor is varied according to the invention as a function of the prevailing wind speed by using power electronics and the control apparatus, which is preferably formed from two or more control modules, so that the power production from the installation is always maximized.

The configuration or apparatus in this case has one or more wind power installations, wind energy installations or wind energy converter systems (WECS), without gearboxes and located in particular in the area of the high seas close to the coast (offshore). The apparatus has a tower with a height of several tens of meters, and has a wind turbine with a generator unit. The wind energy installations and their generator units are electrically connected in parallel, and are connected or coupled indirectly to one another, on the DC voltage side via a common capacitive DC voltage intermediate circuit.

In the case of a modular control apparatus, each generator unit each has an associated control module in the control apparatus which, in order to reduce the length of the cable runs and thus the switching distance and length of the control path as well as the control times, is preferably located in the immediate vicinity of the generator unit, or is integrated in it, although, if required, it can also be accommodated separately from the actual wind energy installation, in a switching station on the land, for example when the control apparatus is not modular.

The control apparatus has at least three differently configured control module groups or functional control assemblies which are:

control modules for the generator units,

control modules for the active inverter units on the grid side, and

a higher-level control module, which acts as an interface between the control modules for the generator units and the active inverter units and carries out separate tasks across the system, for example, in the event of any faults or malfunctions occurring, the tripping or operation of protective apparatuses integrated in the circuitry and, possibly, the recording of the locally prevailing wind speeds at the respective wind energy installations, and the determination of a wind speed averaged over the entire wind park.

All of the control modules are preferably in the form of digital circuit complexes, each having at least one digital signal processor, but may also be hard-wired, using corresponding analog control elements, such as PI regulators, PT regulators, two-point regulators, low-pass filters, subtractors, multipliers, comparators and amplifiers.

Each generator unit in a wind energy installation has one synchronous generator, a diode rectifier that is electrically connected in series with it, an active electronic power controller for providing the field excitation power (field controller), and a control module for closed-loop and open-loop control of the generator unit and of its electronic power assemblies. This also includes, in particular, the recording and further processing of relevant system information, for example, the machine currents, the terminal voltages and the rotation speed of the generator, as well as communication and data and/or information interchange with the higher-level control module in the control apparatus.

The synchronous generator is in this case connected directly, that is to say without any intermediate gearbox, to the wind turbine of the wind energy installation and to its turbine shaft. The rotation speed of the turbine is generally about 18 to 25 revolutions per minute, but may also increase above this or fall below it. Since the generator is driven directly at rotation speeds in the abovementioned slow rotation speed range, the synchronous generator must preferably be designed to have a large number of poles, with several tens or hundreds of pole pairs. The synchronous generator has a magnetic mixed excitation system, which has both permanent magnets and electrical field or excitation windings. However, it may also be designed to have purely electrical field excitation. The static component of the magnetic field and of the magnetic basic or initial field strength are produced by the permanent magnets that are provided while, in contrast, when current is flowing through the field or excitation windings, they produce a field component which can be varied in a controlled manner and whose magnitude is, according to the invention, made dependent on the prevailing wind conditions. The permanent magnets and electrical field windings are integrated in the rotor. The power which has to be provided for excitation and to build up the field that results from it is drawn, using the field controller, from the capacitive DC voltage intermediate circuit and is transmitted to the excitation winding using sliprings and/or transformers.

The excitation windings and field controllers are collected electrically in parallel with the capacitive DC voltage intermediate circuit. The basic magnetic field strength of the synchronous generator can be both increased and reduced by varying the current level and the current direction in the excitation windings by using the field controller, whose output side is connected to the excitation windings and whose input side is connected to the DC voltage intermediate circuit. Each generator unit furthermore has a preferably passive rectifier with a diode bridge, with slow diodes (grid diodes), which rectifies the electrical power generated in the generator and feeds it to the capacitive DC voltage intermediate circuit. The diode rectifier is connected electrically in series with the generator and with the capacitive DC voltage intermediate circuit. The DC voltage outputs of one or more such generator units in the wind park are connected electrically in parallel on the DC voltage side to the capacitive DC voltage intermediate circuit.

Since the rotation speed of the wind turbine and of its rotor are not predetermined in a fixed manner by a specific value but may vary as a function of the wind strength, that rotation speed of the turbine is set for any given wind speed that results in a type of equilibrium between the electrical power which is generated or produced and the mechanical turbine power.

If, in terms of the power that is generated and the rotation speed of the turbine, this equilibrium corresponds to the point of maximum power production, then this ensures that the generator for the wind turbine always supplies the maximum possible power regardless of the respective wind speed. In this case, it is advantageous that it is not absolutely essential to measure or determine the wind speeds that occur.

If the goal is to always operate the wind power installation or wind energy installation in the limit range of maximum possible power production even when the wind speeds are varying to a major extent, then a maximum power coefficient C_{p,max} must be set, corresponding to the optimized speed coefficient λₒₚₜ. For any given wind speed, the respective maximum power P_{T,max} that can be generated or produced by the wind energy installation can be written in the form:

P_{T}=0.5·Cₚ·ρA·v_{W}³ Equation III.

Equation III can also be converted to the form:

$$\begin{matrix}{P}_{T , max} = 0.5 \cdot {C}_{p , max} \cdot ρ \cdot A \cdot {v}_{W}^{3} \\ = 0.5 \cdot {C}_{p , max} \cdot ρ \cdot A \cdot {( \frac{ω \cdot R}{{λ}_{opt}} )}^{3} \\ = [ 0.5 \cdot {C}_{p , max} \cdot ρ \cdot A \cdot {( \frac{R}{{λ}_{opt}} )}^{3} ] \cdot {ω}^{3} \\ = {K}_{p , opt} \cdot {ω}^{3} ,\end{matrix} \qquad Equation IV$$

where ρ is the air density, A is the area over which the wind flows or the area covered by the rotor blades, v_{w} is the wind speed, C_{p,max} is the maximum power coefficient, λₒₚₜ is the optimum speed coefficient, ω is the rotation speed of the wind turbine, R is the radius of the wind turbine and K_{p,opt} is a turbine-specific characteristic variable.

Equation IV clearly shows that the maximum power P_{T,max} which can be produced varies with the third power of the angular velocity ωof the rotor, while in contrast the other parameters (assuming that the air density ρ is constant) are governed essentially by the specific properties and characteristics of the wind turbine.

The generator currents, the terminal voltages and the angular velocity of the synchronous generator are detected and are supplied to the control module for the generator unit. This uses the values mentioned above to determine the reference power P_{G}* as well as the electrical power of the generator P_{G}, which results from the generator or machine currents and from the terminal voltages. The resultant power signal P_{G} is filtered in order, for example, to suppress or to overcome ripple caused by harmonics in the phase currents, and is supplied as a decision value to the input of a switching apparatus or of an operating mode changeover switch. If the power value P_{G} is outside a predetermined power-related hysteresis band, then this may lead to switching between two different control modes or operating modes.

The electrical generator power P_{G} is compared with the predetermined power-related hysteresis range or band in order to decide the operating mode or control mode in which the wind energy installation should be operated. This means whether the installation is controlled at the point of maximum power production in the case of variable turbine rotation speeds, or whether the power production is controlled to achieve a fixed, maximum permissible rotation speed of the wind turbine. A switching signal is generated on a case-specific basis that is used to initiate the switching to the respective other operating mode, and generates a reference power signal P_{G}* that corresponds to the respective operating mode.

The switching between the installation being controlled at the point of maximum power production in the case of variable turbine rotation speeds and being controlled for power production at a constant wind turbine angular velocity is carried out using a switching apparatus which is operated within the power-related hysteresis band, in order to in this way prevent jittering or flickering of the signal due to continual switching between the operating modes. The electrical power that is produced by the generator P_{G} is in this case used, after being passed through a low-pass filter, as a decision parameter for the generation of a switching signal for switching between the two control modes or operating modes.

Until the wind turbine reaches the maximum permissible angular velocity, and until the power range as identified by the hysteresis band is exceeded, the reference power P_{G}* is determined using Equation IV, so that P_{G}*=P_{T,max}. However, once the maximum permissible rotor angular velocity, or a power range which corresponds to this rotation speed and which is above the hysteresis band, is reached, so that it no longer appears to be advisable (from the point of view of safety-relevant aspects, material loads or wear) to increase the rotation speed or angular velocity of the turbine shaft any further, then the reference power P_{G}* is generated by using a rotation speed control apparatus or rotation speed adjustment apparatus, which is integrated in the control module for the generator unit and at the same time limits the angular velocity of the shaft to the maximum permissible value.

At the same time, care is taken to ensure that this rotation speed value is maintained until the electrical power from the generator P_{G} has fallen below the power range that is predetermined by the hysteresis band. If the power falls below the power range which is predetermined by the hysteresis band, then a change is once again made to the control mode with variable turbine or generator rotation speeds, in which the reference power P_{G}* is once again determined using Equation IV.

The control module in the generator unit continually compares the reference power P_{G}* with the electrical power of the generator P_{G}. If there is a difference between the reference power P_{G}* and the value of the electrical power from the generator P_{G}, then the power difference that results from this is used to operate a proportional/integral regulator, which produces a reference current I_{E}* for driving the field controller of the generator unit, and thus for open-loop or closed-loop control of the variable excitation field for the synchronous machine. The variable excitation field for the generator is fed to the generator unit via the field controller which is, for example, in the form of a step-down converter, and is connected on the input side to the capacitive DC voltage intermediate circuit. The excitation field and hence the torque of the generator are in this case changed such that the power difference between the reference power P_{G}* and the electrical generator power P_{G} disappears.

Corresponding current regulation allows the field current or excitation current to be varied quickly as a function of the reference current I_{E}*. The rate of change is limited by the induction of the excitation winding, and the time constant of the excitation field. The excitation field thus assumes its new value immediately, limited only by its time constant. This results in the electrical generator power P_{G} being rapidly matched to the reference power P_{G}*.

If the voltage of the capacitive DC voltage intermediate circuit is kept constant when using the abovementioned control method, then this can lead to a generator current with gaps when the wind strengths are low. This is due to the fact that, in the conditions mentioned above, the control system tries to reduce the rotation speed of the turbine in order to achieve an optimum ratio between the rotation speed and the wind speed, and hence the point of maximum power production, but at the same time the voltage of the capacitive DC voltage intermediate circuit should be kept at a constant, high level. In consequence, the field excitation and field strength must be increased simultaneously, in order to increase the electromotive force on the generator side. A comparatively small current is sufficient to apply the correspondingly required real power. In addition, current can always flow whenever the electromotive force on the generator side exceeds the voltage in the capacitive DC voltage intermediate circuit, which may result in gaps in the current which results from a low level of power production.

This can optionally be avoided, according to the invention, by controlling the voltage of the capacitive DC voltage intermediate circuit as a function of the mean wind speed in the wind park.

For this purpose, in addition to the control method mentioned above, the wind speeds which occur at the individual wind energy installations must in each case be measured and must be transmitted to the higher-level control module in the modular control apparatus (which is preferably accommodated in a switching station that is located on the coast), where they are processed further. The control module then uses the data provided to determine a mean wind speed averaged over the entire wind park. The mean wind signal that is obtained in this way is then smoothed using a low-pass filter, and is supplied to the control modules for the active inverter units on the grid side. The reference voltage U_{dc}* which is produced in the control modules for the capacitive DC voltage intermediate circuit and for the active inverters that are located on the grid side is in this case obtained as a linear function of the filtered mean wind signal. In order to ensure that the semiconductor components that are used are operated safely, the voltage value of the DC voltage intermediate circuit is limited to a minimum of 80% of its original value, and to a maximum of 120 to 140% of its original value. This principle can also be used for higher voltage values.

The electrical power which is generated or produced by the respective generator is rectified using a diode rectifier and is transmitted from the wind energy installation or wind park that is on the high seas and close to the coast, via an underwater DC cable, which is at medium-voltage or high-voltage level, to a switching or intermediate station that is located on land or on the coast. The underwater DC cable is in this case part of the capacitive DC voltage intermediate circuit.

The switching or intermediate station has an interface for inputting power into the composite or load grid system. The interface has at least one active inverter unit on the grid side. Each active inverter unit has an inverter using pulse-width modulation (PWM inverter) which, depending on the voltage in the DC voltage intermediate circuit and on the rated power limit of the wind energy installations, is for example, a two-point or multipoint inverter fitted with thyristors, in particular IGCTs (Integrated Gate Commutated Thyristors), GTOs (Gate Turn-Off Thyristors, ETOs, MCTs (Metal Oxide Semiconductor Controlled Thyristors), MTOs (Metal Oxide Semiconductor Turn-Off Thyristors) or a two-point or multipoint inverter fitted with transistors, in particular IGBTs (Insulated Gate Bipolar Transistors). An inverter fitted with SiC semiconductor switches is also possible and may be used. Furthermore, for each active inverter unit that is present, the switching station also has in each case one associated control module and the higher-level control module for the modular control apparatus.

Contrary to known arrangements based on synchronous generators and thyristor/GTO converters with a direct current link, the lack of the large smoothing inductors required there is, in particular, advantageous. The use of a diode rectifier for rectification of the electrical power generated by the respective generator is also advantageous, because of the low costs, the high reliability, the low excitation powers that need to be provided, and the high efficiency of passive rectifiers in comparison to known arrangements.

The power that is generated is once again fed into the composite grid system or load grid system with a power factor of unity, or with some other predetermined value with a sinusoidal grid current. The inverter units that are located on the grid side are connected to the composite or load grid system via one or more transformers for voltage matching, and these transformers can be disconnected from the supply grid system by at least one circuit breaker.

When a short-circuit fault occurs in one or more of the inverter units that are located on the grid side, these inverter units can be isolated from the generator units by opening appropriate circuit breakers. Since, in a situation such as this, it would be possible for intermediate circuit capacitors that are used to be at risk of being overcharged by the energy generated, a DC chopper is connected in parallel in the DC voltage intermediate circuit, in order to dissipate the energy that is generated before the generating units or the generator units can be switched off.

In the event of a malfunction or failure of the diode rectifier that is located on the generator side, a blocking diode advantageously prevents the power that is generated from being fed in from parallel units to the faulty diode bridge.

Further protective measures can be integrated in the basic configuration, and may be used as required.

Other features which are considered as characteristic for the invention are set forth in the appended claims.

Although the invention is illustrated and described herein as embodied in a method and apparatus for controlling the power of a wind energy installation without a gearbox by electronically varying the speed of the generator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic illustration of an electronic power configuration of a wind park that is on the high seas, but close to the coast;

FIG. 2 is a block diagram of the basic configuration of a modular control and monitoring apparatus;

FIG. 3A is a block diagram of a control loop for keeping the voltage in the capacitive DC voltage intermediate circuit constant;

FIG. 3B is a block diagram of an optional control loop in which the voltage in the capacitive DC voltage intermediate circuit can be varied as a function of a mean wind speed;

FIG. 4 is a graph showing the profile of the power coefficient CP as a function of the speed coefficient A;

FIG. 5 is a graph showing the power/speed characteristics for a 1.5 MW wind turbine and for wind speeds in the range between 5 and 15 m/s;

FIG. 6A is a graph showing the simulation of the wind speed, on which the control method is based, as a function of time;

FIG. 6B is a graph showing the rotation speed of the wind turbine that results from the simulation of the control method, as a function of time;

FIG. 6C is a graph showing the excitation of the generator that results from the simulation of the control method, as a function of time; and

FIG. 6D is a graph showing the electrical power produced by the generator, which results from the simulation of the control method, as a function of time.

### DESCRIPTION OF THE PREFERRED EMBODIMENTS

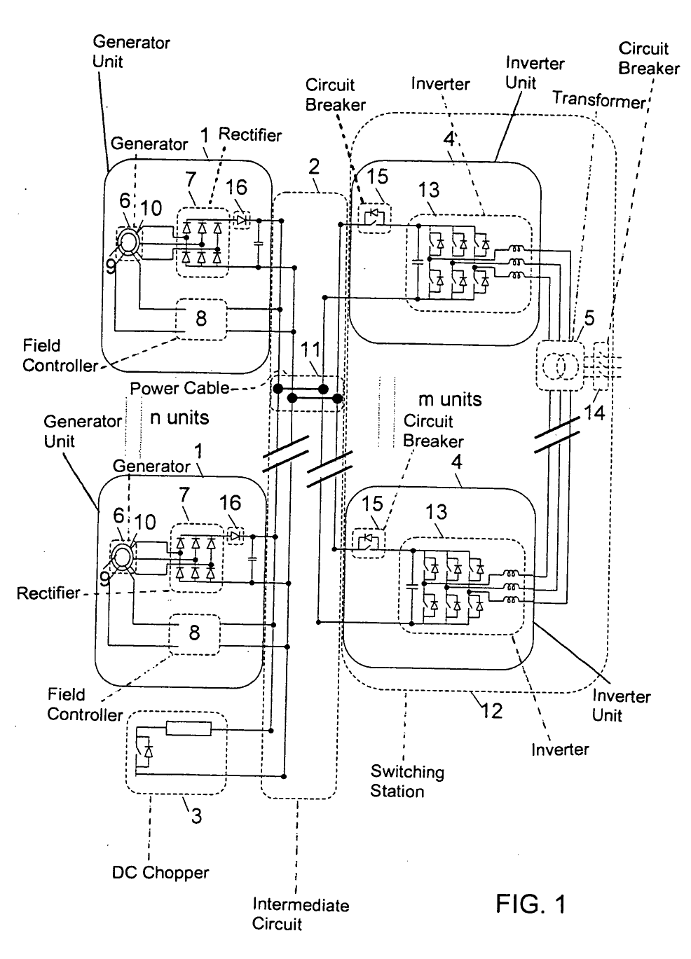

Referring now to the figures of the drawing in detail and first, particularly, to FIG. 1 thereof, there is shown a schematic illustration of the power electronics of a wind park that is on the high seas, but close to the coast. A wind park such as this accordingly has one or more wind power or wind energy installations. Each of the wind power or wind energy installations has: a wind turbine with a generator unit 1, a capacitive DC voltage intermediate circuit 2 with a DC chopper 3, at least one active inverter unit 4 that is not located on the generator side, and at least one transformer 5 for inputting the generated electrical power into the grid system.

The generator unit 1 of each wind energy installation in the example shown here in each case has a three-phase synchronous generator 6 and a diode rectifier 7 connected in series with it. The three-phase synchronous generator 6 preferably has a large number of poles and is connected directly to the wind turbine of the wind energy installation, and to its turbine shaft. The three-phase synchronous generator 6 has a magnetic mixed excitation system, which not only has permanent magnets integrated in the rotor 9 but also has electrical field or excitation windings. However, it can also be excited exclusively electrically. The power that needs to be provided for excitation and the field structure that results from it is drawn from the capacitive DC voltage intermediate circuit 2 in a controlled manner using a field controller 8, and is transmitted using sliprings and/or transformers to the rotor 9 and to its excitation field. Each generator unit 1 furthermore has a passive diode rectifier 7 with a three-phase diode bridge that rectifies the electrical power that is generated in the stator 10 of the three-phase synchronous generator 6, and introduces it into the capacitive DC voltage intermediate circuit 2. The three-phase diode bridge is connected between the stator 10 and the DC voltage intermediate circuit 2. The DC voltage outputs of one or more such generator units 1 in the wind park are connected in parallel with one another to the capacitive DC voltage intermediate circuit 2. The electrical power which is input at sea into the capacitive DC voltage intermediate circuit 2, part of which is in the form of an underwater DC power cable 11, is passed to a switching station or intermediate station 12, which is on the land or on the coast and has at least one interface for inputting power into the composite grid system or load grid system. The switching station 12 includes at least one active inverter unit 4 which is on the grid side and in each case has a three-phase inverter 13 with pulse-width modulation (PWM inverter) which, depending on the rated voltage of the DC voltage intermediate circuit 2 and on the rated power limit of the wind energy installations, is a two-point or multipoint inverter that is fitted with thyristors, transistors or SiC semiconductor switches. In this case, it is also possible for two or more inverters to be connected in parallel, in which case they can also be fed via phase-shifted three-phase systems. Phase-shifted three-phase systems such as these may, for example, be formed by different transformer switching groups. The power which is generated is once again fed into the composite grid system or load grid system at a power factor of unity or at some other predetermined value with a sinusoidal grid current. The active inverter units 4, which are not located on the generator side, are connected to the composite grid system or load grid system via one or more transformers 5 that are separated from the supply grid system by at least one circuit breaker 14. When a short-circuit fault occurs in one or more of the inverter units 4 that are located on the grid side, they can be isolated from the generator units 1 by opening the appropriate circuit breaker 15. Since, in a situation such as this, intermediate circuit capacitors that are used are at risk of being overcharged by the energy that is generated, a DC chopper 3 is connected in parallel with the DC voltage intermediate circuit 2, in order to make it possible to dissipate the energy that is generated before the generating units or the generator units 1 are switched off. In the event of a malfunction or failure of the diode rectifier 7 that is located on the generator side, a blocking diode 16 furthermore advantageously prevents the power that is generated from being fed in from parallel units to the faulty diode bridge, for example in the event of a short circuit.

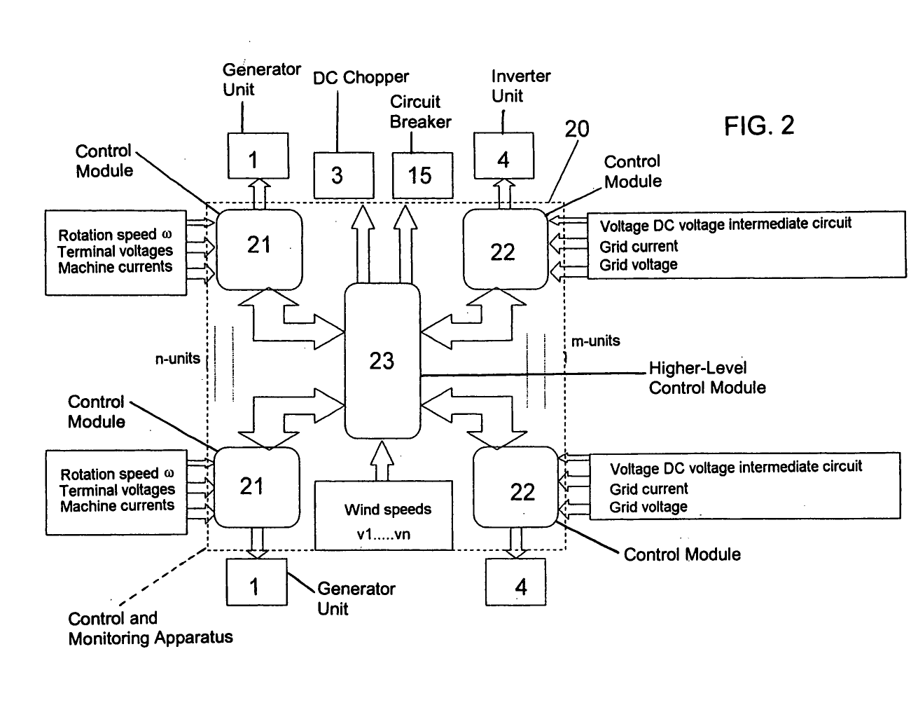

Both the entire wind park which is on the high seas, but is close to the coast and the individual wind energy installations as well as their power electronic equipment components are monitored and controlled by the modular control and monitoring apparatus 20 which is shown in FIG. 2. The control apparatus 20 in this case includes control modules 21 for regulating and monitoring the generator units 1. Each generator unit 1 has a separate associated control module 21. Control modules 22 are provided for controlling and monitoring the active inverters 13 that are not located on the generator side. Each inverter 13 on the grid side has a separate associated control module 22. A higher-level control module 23 monitors the other control modules 21 and 22, communicates with them, and carries out wider functions, such as the operation or activation of circuit breakers 15 and/or DC choppers 3 when faults occur.

The control module 21 of a generator unit 1 detects as input variables, for example, the terminal voltages, the machine currents and the rotation speed ω of the generator and, according to the invention, uses them to produce a reference current I_{E}*, which is intended for the field controllers 8 for the respective generator unit. The reference current I_{E}* is for adapting the excitation current and thus the torque and the rotation speed ω of the generator and, as a consequence of this, controls or optimizes the power produced by the wind energy installation.

The control module 22 for each active inverter unit 4 on the grid side receives, as input signals, the voltage U_{dc} of the capacitive DC voltage intermediate circuit 2, the grid system voltage, the grid system current and, optionally from a higher-level control module, a reference voltage U_{dc}* for adapting or modifying the voltage in the capacitive DC voltage intermediate circuit 2.

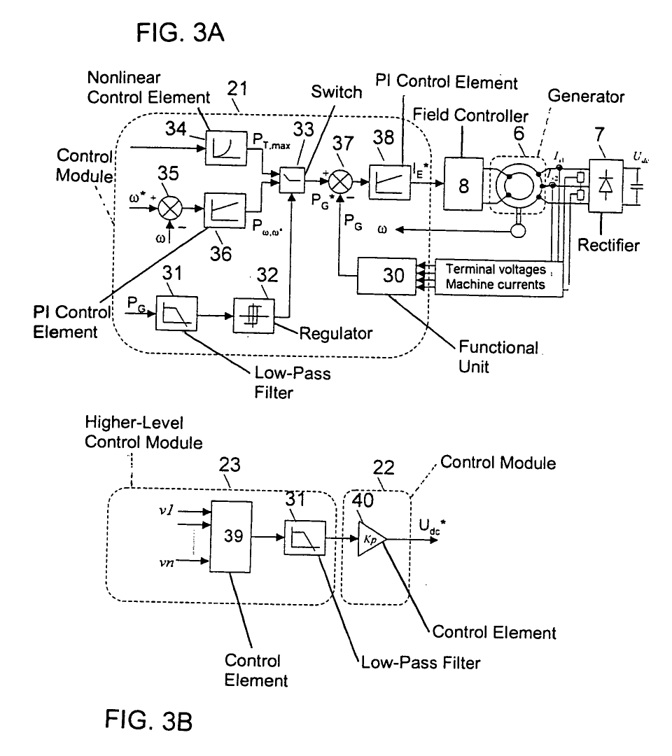

FIG. 3A shows a schematic illustration of the control loop for maximizing the power produced by a wind energy installation.

The machine currents and terminal voltages of the generator as well as its instantaneous rotation speed ω are detected, and the electrical power of the generator P_{G} is determined in a functional unit 30 in the control module 21 which is associated with that generator unit 1. The resultant power signal is filtered via a low-pass filter 31 and is compared by a two-point regulator 32 (with hysteresis) with a power-related hysteresis band or range that is determined by the regulator and is defined by an upper and a lower limit value. If the power value P_{G} is outside the given hysteresis band, then the two-point regulator 32 if necessary generates a switching signal which moves a switching apparatus or a switch 33 for switching between the two possible control modes. That is to say, a mode for control at the point of maximum power production with variable rotor rotation speeds, and a mode for control for power production from the wind energy installation at a fixed, maximum permissible rotor rotation speed. reference current I_{E}*.

In this case, a distinction is drawn between a total of four possible situations:

1. If the control system is instantaneously operating with variable rotor rotation speeds ω and if the determined electrical generator power P_{G} is within or below the power-related hysteresis band that is predetermined by the two-point regulator 32, then the regulator 32 generates a switching signal that causes the switch 33 to use the reference power P_{G}* for the rest of the analysis, as determined using a nonlinear control element 34 in accordance with Equation IV and as a function of the rotation speed ω, where P_{G}*=P_{T,max}. This does not result in switching to the other control mode, with variable wind turbine rotation speeds ω.

2. If the control system is instantaneously operating with a variable rotor rotation speed wand if the determined electrical generator power P_{G} is above the power-related hysteresis band that is predetermined by the two-point regulator 32, then the regulator 32 generates a switching signal which causes the switch 33 to use a reference power P_{G}* for the rest of the analysis. This reference power P_{G}* is proportional to the difference (which is formed by a comparator 35) between the instantaneous rotation speed wand the maximum permissible rotation speed ω*, and is generated by a PI control element 36. In this case, P_{G}*=Pω,ω*. This results in switching to control the power production at the maximum permissible rotation speed ω* of the wind turbine.

3. If the control system is instantaneously operating at the fixed rotor rotation speed ω* and if the calculated electrical generator power P_{G} is within or above the power-related hysteresis band which is predetermined by the two-point regulator 32, then the existing control mode is retained and the PI control element 36 generates a reference power P_{G}* which is proportional to the difference (which is formed in the comparator 35) between the instantaneous rotation speed ω and the maximum permissible rotation speed ω*. In this case, P_{G}*=Pω,ω*. This reference power P_{G}* is used for the rest of the control method. Control based on a constant rotation speed ω* is maintained, and in consequence no switching takes place to the other operating mode.

4. If the control system is instantaneously operating at a fixed rotor rotation speed ω* and if the determined generator power P_{G} is below the power-related hysteresis band which is predetermined by the two-point regulator 32, then the two-point regulator 32 generates a switching signal which causes the switch 33 to use the reference power P_{G}* for the rest of the method as determined by a nonlinear control element 34 using Equation IV and as a function of the rotation speed ω, where P_{G}*=P_{T,max}. Variable wind turbine rotation speeds ω are allowed and switching takes place to the other control mode, that is to say control at the point of maximum power production with variable rotation speeds.

The reference power P_{G}* which is selected using the switch 33 is first of all compared in a comparator 37 with the electrical generator power PG. A PI control element 38 then produces a reference current I_{E}* that is proportional to the power difference and is then supplied to the field controller 8 for the respective generator unit in order to adapt the excitation current.

Controlled by the reference current I_{E}*, the field controller 8 adapts and controls the excitation current and hence the generator torque such that the power difference between the reference power P_{G}* and the generator power P_{G} disappears, thus allowing control and limiting of the rotation speed and hence control and optimization of the power produced by the wind energy installation without measuring and without knowing the prevailing wind speeds.

Since each generator unit 1 has its own associated control module 21, this also ensures separate, individual control of two or more wind energy installations which are interconnected in a group, for example, in a wind park and in particular in a wind park on the high seas, but close to the coast. This is particularly advantageous when differences in wind strength occur as a result of different locations within the wind park, and which can then be regulated out and compensated for individually by the respective wind energy installations.

Furthermore, the electronic power control of the power production by adapting the generator torque, in comparison to varying the torque of the wind turbine by adjusting the angles of the rotor blades, allows a comparatively faster or shorter control cycle. The situation is also assisted or supported by the local proximity between the control module 21 carrying out this process and the generator unit 1.

Since the voltage in the DC voltage intermediate circuit 2 is kept constant in the abovementioned control and monitoring method, it is possible for gaps to occur in the current waveform when the wind strengths are low. This can optionally be avoided by adapting the voltage value in the DC voltage intermediate circuit 2 as a function of a wind speed averaged over the entire wind park as shown in FIG. 3b.

As is shown in FIG. 3B, in addition to the control method that is known from FIG. 3A, it is also in this case necessary to record the wind speeds v₁ . . . vₙ which occur at each of the individual wind energy installations. The wind speeds v₁ . . . vₙ which are determined are supplied to the higher-level control module 23, and a wind speed that is averaged over the entire wind park is determined by a control element 39. The resultant signal for the mean wind speed is smoothed by a low-pass filter 31 and is supplied to the control modules 22 for the active inverter units 4. The reference voltage U_{dc}*, which is for the DC voltage intermediate circuit 2 for the inverters 13 that are located on the grid side, is determined as a linear function of the filtered signal by an appropriate control element 40 and is supplied to the appropriate inverter 13, thus resulting in the voltage U_{dc} in the capacitive DC voltage intermediate circuit 2 being adapted as a function of the wind speed, and hence of the power production.

The control and actuating elements that are shown in FIGS. 3A and 3B may preferably be in the form of digital signal processors, but may also be formed by hard wiring for appropriate analog control apparatus or control elements.

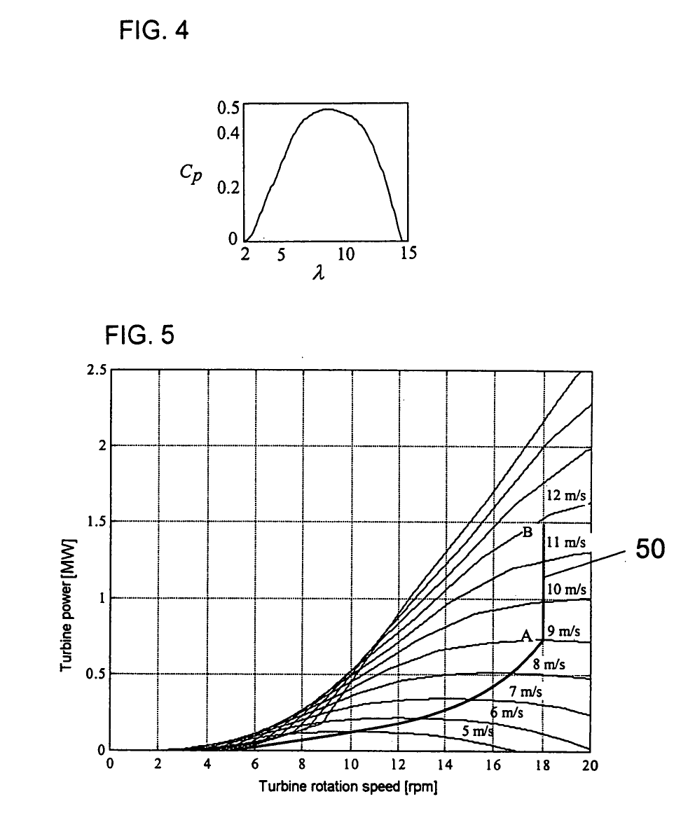

FIG. 4 shows the curve profile for the power curvature Cₚ as a function of the speed coefficient A as being representative of a turbine. The characteristic power/speed characteristic can be determined using the illustrated curve, using Equation I and Equation II.

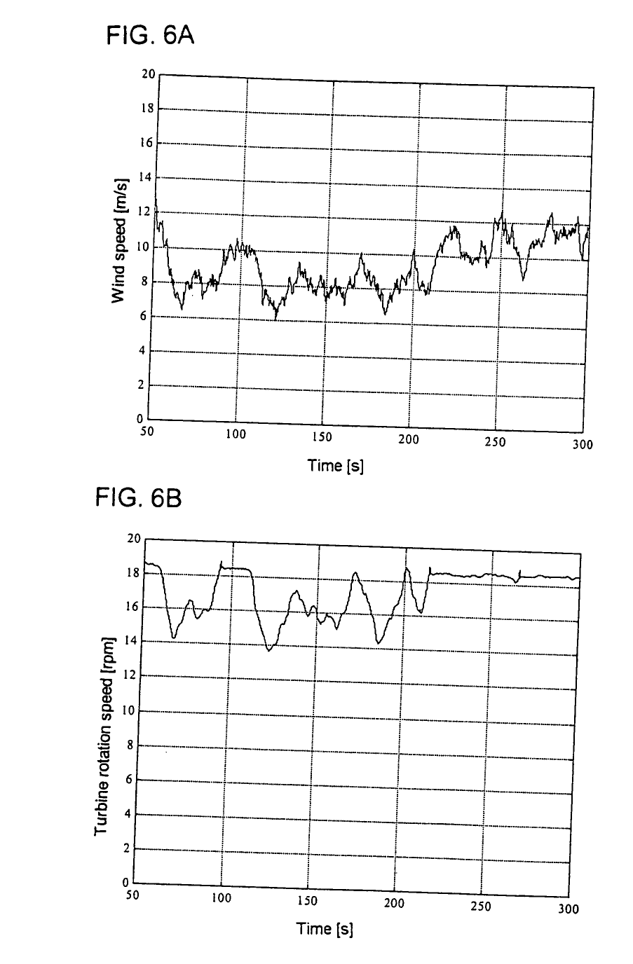

A characteristic such as this, which is typical for wind turbines, is shown in FIG. 5 for a wind turbine with a rating of 1.5 MW and for wind speeds in the range between 5 m/s and 15 m/s. This clearly shows the shift in the angular velocity or rotation speed of the turbine as the wind speed increases, in the direction of increasing values for the point at which the maximum power is produced. The solid thick line 50 describes the maximum power production, with the point A marking the switching point for control with variable rotation speeds to control at a fixed, maximum permissible rotation speed. Power values between the points A and B are reached by varying the generator torque with a constant rotation speed. It is obvious to those skilled in the art that a comparatively high wind strength or wind speed with correspondingly high turbine shaft rotation speeds also correspondingly allows the wind energy installation to produce a high output power level.

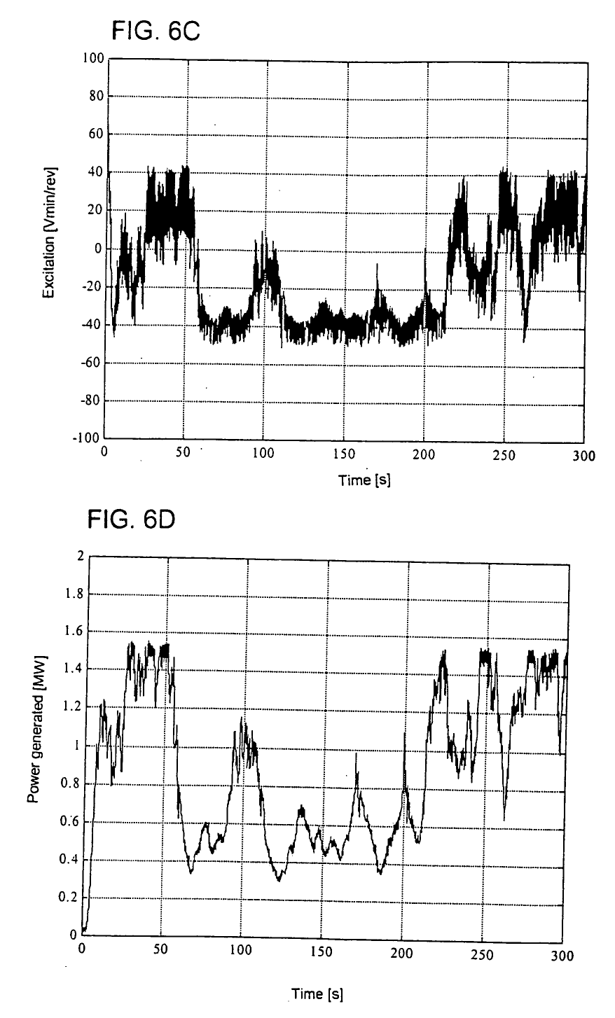

The curves that are shown in FIGS. 6A, 6B, 6C and 6D result from a simulation of the described control method when the voltage U_{dc} in the DC voltage intermediate circuit 2 is kept constant, and with the simulation having been based on the following machine data:

Specific data for the synchronous generator 6:

| | |
|---|---|
| Rated power | 1.5 MW |
| Rated terminal voltage | 3.3 kV, three-phase |
| Number of poles | 200 |
| Rated angular velocity of | 18 rpm |
| the shaft | |
| Rated phase current | 262.4 A |
| Drive-side electromotive | 165.5 Vmin/revolution |
| force | (per phase) |
| Inductance of the | 46 mH (assuming that |
| synchronous generator | xₛ = 1.2 pu) |

Specific data for the wind turbine:

| | | |
|---|---|---|
| Rated power | 1.5 | MW |
| Rated angular velocity of | 18 | rpm |
| the shaft | | |
| Radius of the rotor | 33 | m |
| Area over which the wind flows | 3421 | m² |
| Torque | 1062937 | kgm² |

Cₚ-λ characteristic as in FIG. 4.

If the wind speed that varies with time as shown in FIG. 6A is compared with the angular velocity of the turbine shaft recorded as a function of time as shown in FIG. 6B, then it can be seen that the shaft speed or rotation speed of the wind turbine varies approximately with the wind speed, which shows that the control method provides control, as expected, at the point at which the turbine is producing the maximum power.

FIG. 6C shows the time profile for the excitation of the generator 6 plotted in Vmin/revolution, where the voltage in the capacitive DC voltage intermediate circuit 2 has been kept constant. This largely corresponds to the time profile for the power that is generated or produced, as shown in FIG. 6D.

The rotation speed is controlled, or is limited or fixed, at the maximum permissible value precisely at the point when the power which is generated or produced exceeds the upper predetermined power threshold of 800 kW, and is disconnected or switched off again when the power falls below the predetermined lower power threshold of 650 kW. This behavior, which corresponds to the control process as shown in FIG. 3A and as described in the associated description, can be understood with reference to FIGS. 6B, 6C and 6D. The turbine-specific maximum permissible angular velocity ω* is in this case approximately 18 rpm. Despite changing wind speeds, the rotational speed of the wind turbine is kept virtually constant at the maximum permissible value by using the abovementioned control method after about 220 seconds, as shown in FIG. 6B. At the same time, as is shown in FIG. 6C and FIG. 6D, it can, however, be observed that both the excitation and the power that is produced largely follow the changing wind speed. Fluctuations in the generated power can be observed to an increased extent in the operating mode in which the turbine is rotating at a constant speed. However, a behavior such as this should be expected since, when the wind turbine speed is constant, there is no change in the stored energy and, apart from minor losses, the generator power corresponds approximately to the turbine power.

The energy yield over the simulation time period was 74 kWh, which corresponds to approximately 12% more than the yield of the uncontrolled system with the same structure, with a constant field excitation and a constant voltage U_{dc} in the DC voltage intermediate circuit 2. When considered over a lengthy time period, the energy yield can probably be increased further. Since the operating point always moves along the desired locus curve of the turbine characteristic, this is the maximum energy that can be produced for a given wind profile.

It should be mentioned at this point that the control and operating method described so far is not restricted to the technical data used as the basis here, but retains its validity for all power classes and turbine characteristics.

Simulations carried out on the basis of control with a variable voltage U_{dc} in the DC voltage intermediate circuit 2 have also resulted in a continuous current waveform for small or low wind strengths. When the basic excitation was also kept constant at 187.5 Vmin/revolutions as in the present case, then there is a slight rise in comparison to the controllable component of the field excitation. This is due to the fact that, assuming that the emitted power is constant, a reduction in the terminal voltage results in a rise in the field excitation.

We claim:

1. A method for electronically controlling at least one wind energy installation without a gearbox, the wind energy installation having a wind turbine with a generator unit including a synchronous generator, a diode rectifier, and a field controller, the method which comprises:
using a control apparatus for, based on power electronics, setting or regulating a torque of the generator and therefore a rotational speed of the turbine to prevailing wind conditions for producing a maximum power in the wind energy installation; and
as a function of the prevailing wind conditions, switchably operating the wind energy installation in a control or operating mode with a variable rotor speed and a variable turbine rotational speed ω or in a control or operating mode at a predetermined fixed turbine rotational speed ω*.

2. The method according to claim 1, which further comprises:
forming a group of wind energy installations by using a capacitive DC voltage intermediate circuit to couple a plurality of wind energy installations without gearboxes.

3. The method according to claim 1, wherein the wind energy installation is located on a sea and close to a coastline.

4. The method according to claim 1, wherein the wind energy installation is located above a waterline of an ocean.

5. The method according to claim 1, wherein the step of setting or regulating the torque of the generator and therefore the rotational speed of the turbine is performed by controlling and varying a field strength of an excitation field for the generator.

6. The method according to claim 5, which further comprises: producing the excitation field of the generator by using a mixed excitation system including a plurality of permanent magnets and a plurality of field or excitation windings through which current flows.

7. The method according to claim 5, which further comprises: producing the excitation field of the generator by using a purely electrical excitation.

8. The method according to claim 1, which further comprises: operating the wind energy installation in the control or operating mode with the variable rotor speed and the variable turbine rotational speed such that the wind energy installation is controlled at a maximum power production point.

9. The method according to claim 1, which further comprises:
operating the wind energy installation in the control or operating mode at the fixed turbine rotational speed ω*; and
controlling the fixed turbine rotational speed ω* to be a maximum permissible turbine rotation speed ω*.

10. The method according to claim 1, which further comprises:
during continuous operation, alternately switching the wind energy installation between the control or operating mode with the variable rotor speed and the variable turbine rotational speed ω and the control or operating mode at the predetermined fixed turbine rotational speed ω*, as a function of a generator power P_{G} and prevailing wind conditions, as a function of a predetermined power-related hysteresis range or band, and as a function of a selected control or operating mode.

11. The method according to claim 1, which further comprises:
determining an electrical generator power P_{G} from terminal voltages and machine currents;
comparing the electrical generator power P_{G} with a predetermined power range and/or power-related hysteresis band;
as a function of the comparing step, choosing either the control or operating mode with the fixed rotational speed ω* or the mode with the variable turbine rotation speed ω, and determining a reference power P_{G}* corresponding to a maximized power production;
obtaining a power difference by comparing the reference power P_{G}* with the electrical generator power P_{G} and producing a reference current I_{E}* proportional to the power difference;
supplying the reference current I_{E}* to the field controller for adapting an excitation for the generator, the reference current I_{E}* causing the field controller to draw power in a controlled manner from a capacitive DC voltage intermediate circuit and to supply the power to the excitation field of the generator for adapting the excitation field of the generator; and
changing the torque of the generator such that the electrical generator power P_{G} corresponds to the reference power P_{G}*, resulting in the rotational speed ω being controlled and a power produced by the wind energy installation being controlled and optimized.

12. The method according to claim 11, which further comprises:
using a lower power threshold value and an upper power threshold value to define the predetermined power range and/or the predetermined power-related hysteresis band.

13. The method according to claim 12, which further comprises:
in the control or operating mode with the variable turbine rotational speed, until the upper power threshold value of the predetermined power-related hysteresis band is exceeded by the electrical generator power P_{G}, determining the reference power P_{G}* using a following relationship:
$$= [ 0.5 \cdot {C}_{p , max} \cdot ρ \cdot A \cdot {( \frac{R}{{λ}_{opt}} )}^{3} ] \cdot {ω}^{3} = {K}_{p , opt} \cdot {ω}^{3} ,$$
ω being the rotational speed of the wind turbine, C_{p,max} being the maximum power coefficient, A being an area over which wind flows, R being a radius of the rotor, λₒₚₜ being an optimum speed coefficient, ρ being an air density assumed to be constant, and K_{p,opt} being a characteristic value specific for the wind energy installation.

14. The method according to claim 12, which further comprises:
between the generator power P_{G} exceeding the upper power threshold value of the predetermined power-related hysteresis band and the electrical generator power P_{G} falling below the lower power threshold value, keeping the turbine rotational speed ω constant at the fixed rotational speed ω*, which is a maximum permissible rotation speed value, by using the control apparatus to vary the excitation field and hence the generator torque and to generate a corresponding reference power P_{G}*=Pω,ω*; and
not changing the wind energy installation to the control or operating mode with the variable wind turbine rotational speed ω until the generator power P_{G} falls below the lower power threshold value.

15. The method according to claim 1, which comprises:
forming a group of wind energy installations by using a capacitive DC voltage intermediate circuit to couple a plurality of wind energy installations without gearboxes;
varying a voltage level of the DC voltage intermediate circuit as a function of a mean wind speed to prevent a discontinuous current waveform from the generator at low wind strengths;
recording a wind speed at each of the plurality of wind energy installations within a wind park and passing the wind speed to the control apparatus;
obtaining a filtered mean wind signal by determining a mean wind speed from individual information items using the control apparatus and smoothing a resultant signal using a low-pass filter;
varying a voltage from the DC voltage intermediate circuit, which is used as a reference voltage U_{dc}* for a respective inverter unit on a grid side, as a linear function of the filtered mean wind signal; and
varying a voltage U_{dc} of the DC voltage intermediate circuit using an active inverter on the grid side.

16. The method according to claim 1, which further comprises:
keeping a voltage U_{dc} of a DC voltage intermediate circuit constant.

17. The method according to claim 1, which further comprises:
using sliprings to provide an electrical supply for field or excitation windings of a rotor of the generator.

18. The method according to claim 1, which further comprises:
without using sliprings, using a transformer to provide an electrical supply for field or excitation windings of a rotor of the generator.

19. The method according to claim 1, which further comprises:
forming a group of wind energy installations by using a capacitive DC voltage intermediate circuit to couple a plurality of wind energy installations without gearboxes;
using a diode rectifier to rectify electrical output power generated by the generator of at least one of the plurality of wind energy installations; and
introducing the electrical output power into the common capacitive DC voltage intermediate circuit to pass on the electrical output power with low losses.

20. The method according to claim 1, which further comprises:
forming a group of wind energy installations by using a capacitive DC voltage intermediate circuit to couple a plurality of wind energy installations without gearboxes;
providing at least one active inverter unit coupled to a side of the capacitive DC voltage intermediate circuit opposite the plurality of wind energy installations;
providing at least one transformer connected downstream from the inverter unit; and
drawing electrical power from the capacitive DC voltage intermediate circuit and using the transformer to and the inverter unit to feed the power into a group grid system.

21. The method according to claim 1, which further comprises:
providing the control apparatus with a control module; and
using the control module for open-loop control, closed-loop control and monitoring of the generator unit.

22. The method according to claim 21, which further comprises:
recording machine currents, terminal voltages and a rotational speed ω of the generator;
obtaining a resultant power signal by determining an electrical power P_{G} of the generator;
filtering the resultant power signal to obtain a determined electrical power P_{G};
generating a reference power P_{G}*, and controlling the rotational speed ω of the generator as a function of the determined electrical power P_{G} and a predetermined power-related hysteresis band;
obtaining a power difference by comparing the reference power P_{G}* with the electrical power P_{G};
producing a reference current I_{E}* being proportional to the power difference;
supplying the reference current I_{E}* to the field controller; and
supplying the reference current I_{E}* to a higher-level control module of the control apparatus.

23. The method according to claim 22, which further comprises:
performing the step of controlling the rotational speed ω of the generator such that the rotational speed ω of the generator is at a maximum permissible value ω*.

24. The method according to claim 1, which further comprises:
forming a group of wind energy installations by using a capacitive DC voltage intermediate circuit to couple a plurality of wind energy installations without gearboxes;
providing a plurality of active inverter units coupled to a side of the capacitive DC voltage intermediate circuit opposite the plurality of wind energy installations;
providing the control apparatus with a plurality of control modules and a higher-level control module interacting with the plurality of control modules; and
using each one of the plurality of control modules for monitoring, closed-loop controlling, and open-loop controlling a respective one of said plurality of active inverter units.

25. The method according to claim 24, which further comprises:
using each one of the plurality of control modules for recording and further processing a voltage of the capacitive DC voltage intermediate circuit, a grid voltage and a grid current.

26. The method according to claim 24, which further comprises:
providing each one of plurality of wind energy installations with a generator unit;
providing the control apparatus with a higher-level control module communicating with the plurality of control modules;
providing the control apparatus with a plurality of second control modules, each one of the plurality of second control modules for controlling the generator unit of a respective one of plurality of wind energy installations;
configuring the higher-level control module for communicating with the plurality of the second control modules; and
when a fault occurs, using the higher-level control module for tripping or activating appropriate protective apparatuses.

27. The method according to claim 26, which further comprises: providing the protective apparatuses as circuit breakers and DC choppers.

28. The method according to claim 24, which further comprises:
recording wind speeds at each one of the plurality of the wind energy installations and obtaining a signal by averaging the wind speeds using the higher-level module in the control apparatus; and
obtaining a filtered signal by filtering the signal and then transmitting a corresponding signal to at least one of the plurality of control modules, which then generates a corresponding reference voltage U_{dc}* and passes the reference voltage U_{dc}* to one of the plurality of active inverter units.

29. A configuration for electronically controlling at least one wind energy installation, the configuration comprising:
said wind energy installation being configured without a gearbox, said wind energy installation including a wind turbine having a generator unit circuit coupled to said wind energy installation; and
at least one modular control apparatus for data recording, processing and controlling said generator unit.

30. The configuration according to claim 29, further comprising a plurality of electronic components being controlled by said modular control apparatus.

31. The configuration according to claim 29, further comprising:
a plurality of wind energy installations, each one of said plurality of wind energy installations being configured without a gearbox, each one of said plurality of wind energy installations including a wind turbine having a generator unit with a synchronous generator, a diode rectifier, and a field controller;
said capacitive DC voltage intermediate circuit coupling said plurality of wind energy installations to form a group.

32. The configuration according to claim 31, wherein: said plurality of wind energy installations are located on an ocean and close to a coastline.

33. The configuration according to claim 29, further comprising:
at least one transformer; and
at least one inverter unit having a DC voltage side connected to said capacitive DC voltage intermediate circuit, said inverter unit having an AC side connected to said transformer;
said synchronous generator having a mixed excitation system with a plurality of permanent magnets and a plurality of electrically supplied field or excitation windings;
said diode rectifier having an AC side connected to said synchronous generator;
said diode rectifier having a DC voltage side connected to said capacitive DC voltage intermediate circuit;
said synchronous generator connected directly to said wind turbine, without any intermediate gearbox;
said field controller for supplying said plurality of field or excitation windings;
said field controller having an input connected to said capacitive DC voltage intermediate circuit; and
said field controller having an output connected to said plurality of field or excitation windings.

34. The configuration according to claim 29, further comprising:
at least one transformer; and
at least one inverter unit having a DC voltage side connected to said capacitive DC voltage intermediate circuit, said inverter unit having an AC side connected to said transformer;
said synchronous generator having an exclusively electrically supplied excitation system with a plurality of electrically supplied field or excitation windings;
said diode rectifier having an AC side connected to said synchronous generator;
said diode rectifier having a DC voltage side connected to said capacitive DC voltage intermediate circuit;
said synchronous generator connected directly to said wind turbine, without any intermediate gearbox;
said field controller for supplying said plurality of field or excitation windings;
said field controller having an input connected to said capacitive DC voltage intermediate circuit; and
said field controller having an output connected to said plurality of field or excitation windings.

35. The configuration according to claim 29, wherein said synchronous generator has sliprings.

36. The configuration according to claim 29, wherein said synchronous generator is a three-phase synchronous generator and said diode rectifier includes a three-phase diode bridge.

37. The configuration according to claim 29, further comprising at least one three-phase transformer.

38. The configuration according to claim 29, wherein said synchronous generator is an internal pole machine.

39. The configuration according to claim 29, wherein said synchronous generator has a large number of poles.

40. The configuration according to claim 29, further comprising:
at least one active inverter configured as a two-point or multipoint inverter fitted with a plurality of thyristors;
said active inverter being configured on a side of a grid.

41. The configuration according to claim 40, wherein each one of said plurality of thyristors is selected from a group consisting of IGCTs, GTOs, ETOs, MCTs or MTOs.

42. The configuration according to claim 29, further comprising:
at least one active inverter configured as a two-point or multipoint inverter;
said active inverter being configured on a side of a grid;
said active inverter being fitted with transistors.

43. The configuration according to claim 29, further comprising:
at least one active inverter configured as a two-point or multipoint inverter;
said active inverter being configured on a side of a grid;
said active inverter being fitted with IGBTs.

44. The configuration according to claim 29, further comprising:
at least one active inverter configured as a two-point or multipoint inverter;
said active inverter being configured on a side of a grid;
said active inverter being fitted with SiC semiconductor switches.

45. The configuration according to claim 29, further comprising:
a blocking diode connected between said diode rectifier and said capacitive DC voltage intermediate circuit;
said diode rectifier having a diode bridge;
said blocking diode for protecting said diode bridge of said diode rectifier;
said blocking diode having a forward-biased direction pointing from said diode rectifier toward said DC voltage intermediate circuit.

46. The configuration according to claim 29, further comprising:
at least one active inverter configured on a side of a grid, said active inverter having a DC side; and
a circuit breaker configured between said capacitive DC voltage intermediate circuit and said DC side of said active inverter.

47. The configuration according to claim 29, wherein:
said capacitive DC voltage intermediate circuit includes at least one capacitor bank connected in parallel with said generator unit;
said capacitor bank formed as an intermediate circuit capacitor.

48. The configuration according to claim 29, wherein said capacitive DC voltage intermediate circuit has at least one DC chopper.

49. The configuration according to claim 29, wherein said control apparatus has at least three differently configured control module groups or assemblies.

50. The configuration according to claim 29, further comprising:
a plurality of wind energy installations, each one of said plurality of wind energy installations being configured without a gearbox, each one of said plurality of wind energy installations including a wind turbine having a generator unit with a synchronous generator, a diode rectifier, and a field controller;
said capacitive DC voltage intermediate circuit coupling said plurality of wind energy installations to form a group;
said modular control apparatus including a plurality of control modules; and
each one of said plurality of control modules for separately controlling said synchronous generator of a respective one of said plurality of wind energy installations.

51. The configuration according to claim 29, further comprising:
at least one active inverter configured on a side of a grid;
said control apparatus including a control module and a higher-level control module;
said control module for recording information about said higher-level control module, said control module for recording currents and voltages on said side of said grid, and said control module for recording a voltage in said DC voltage intermediate circuit at said active inverter;
active inverter having equipment components; and
said control apparatus for further processing the currents and the voltages, and for passing resultant information or reference values for control purposes to said equipment components of said active inverter and to said higher-level control module.

52. The configuration according to claim 29, further comprising:
a plurality of wind energy installations, each one of said plurality of wind energy installations being configured without a gearbox, each one of said plurality of wind energy installations including a wind turbine having a generator unit with a synchronous generator, a diode rectifier, and a field controller; and
a plurality of inverter units;
said capacitive DC voltage intermediate circuit coupling said plurality of wind energy installations to form a group;
said control apparatus including at least one higher-level control module, a plurality of control modules for said generator unit of said plurality of wind energy installations, and a plurality of control modules for said plurality of inverter units;
said higher-level control module communicating with said plurality of control modules for said generator unit of each one of said plurality of wind energy installations;
said higher-level control module communicating with said plurality of control modules for said plurality of inverter units;
said higher-level control module configured for recording information or data from external sensors and for further processing the data; and
said higher-level control module configured for supplying instructions resulting from the data appropriate control apparatus and equipment components.

53. The configuration according to claim 29, wherein said control apparatus includes a control module with at least one digital signal processor.

54. The configuration according to claim 29, further comprising:
a switching station located on land or on a coastline;
a plurality of active inverter units;
a plurality of control modules associated with said plurality of active inverter units, said plurality of control modules located in said switching station; and
a plurality of transformers and a higher-level control module located in said switching station.

55. The configuration according to claim 29, further comprising:
a control module integrated in said generator unit or located at least immediately adjacent said generator unit.

56. The configuration according to claim 29, wherein said capacitive DC voltage intermediate circuit has a DC power cable with a length of from several hundred meters to several thousand meters.

57. The configuration according to claim 29, wherein said capacitive DC voltage intermediate circuit includes an underwater DC power cable.

58. The configuration according to claim 29, wherein said modular control apparatus controls a rotational speed of said generator unit.
